(19) United States
(12) Patent Application Publication
(10) Pub. No.: US 2015/0154657 A1
(43) Pub. Date: Jun. 4, 2015

(54) WEB-BASED SOCIAL ADVERTISING SYSTEM AND METHOD

(71) Applicant: Stoltz, LLC, Avondale Estates, GA (US)

(72) Inventors: Leon Stoltz, Atlanta, GA (US); Lance Culpepper, Atlanta, GA (US)

(21) Appl. No.: 14/558,166

(22) Filed: Dec. 2, 2014

Related U.S. Application Data
(60) Provisional application No. 61/910,790, filed on Dec. 2, 2013.

(51) Int. Cl. G06Q 30/02; G06Q 50/00

(52) U.S. Cl. CPC G06Q 30/0276; G06Q 30/0269; G06Q 50/01

(57) ABSTRACT

A system and method for soliciting user-created advertising content is provided including the steps of: providing a web-based social advertising system including a solicitation database, a plurality of user devices, and a plurality of social media networks wherein the solicitation database is in communication with the user devices and the social media networks through a communications network; storing a solicitation request on a data storage device of the solicitation database wherein such solicitation request includes one or more digital media files for use by a user to create advertising content; accessing the solicitation request; accepting a solicitation request; creating advertising content using the plurality of user devices and using the one or more digital media files to create such advertising content; submitting the created advertising content for posting; and posting the created advertising content on the plurality of social media networks.

### CROSS-REFERENCE(S) TO RELATED APPLICATION(S)

This application claims priority to now pending U.S. Provisional Application Ser. No. 61/910,790 to Leon Stoltz and Lance Culpepper for a “Web-Based Social Media Advertising System and Method” which was filed on Dec. 2, 2013, the content of which is incorporated herein by reference in its entirety.

### FIELD

This disclosure relates to the field of web-based marketing and advertising. More particularly, this disclosure relates to a web-based system and method for soliciting user-created advertising content.

### BACKGROUND

Online marketing typically requires subjecting users to one or more ads created by third party advertising agencies. Further, these advertisements are typically subjected to users in such a way that the advertisements are readily recognized by the users as advertisements commissioned by one or more companies. For example, advertisements may be displayed to a user on a user's social media profile or in other contexts in which the user is not actively seeking products from the one or more companies. This type of advertising can often frustrate users by cluttering their social media profiles and discourage the users from purchasing any goods related to the companies.

When “word of mouth” marketing occurs, users often communicate to one another to promote companies' products or services. While word of mouth marketing provides a valuable form of advertising by users, often it is difficult for companies to incentivize one or more users to promote the company by word of mouth marketing.

What is needed, therefore, is a web-based social advertising system and method for encouraging users to promote a company. What is also needed is a way to maximize organic word of mouth advertisements while also verifying the authenticity and acceptability of such advertisements.

### SUMMARY

The above and other needs are met by a system and method for soliciting user-created advertising content. In a first aspect, a method of mass advertisement creation is provided including the steps of: (1) providing a web-based social advertising system including a solicitation database, a plurality of user devices, and a plurality of social media networks wherein the solicitation database is in communication with the plurality of user devices and the plurality of social media networks through a communications network selected from the group consisting of the Internet, an intranet, or a local area network; (2) storing a solicitation request on a data storage device of the solicitation database wherein such solicitation request includes one or more digital media files for use by a user to create advertising content; (3) accessing the solicitation request via the plurality of user devices; (4) accepting a solicitation request via the plurality of user devices; (5) creating advertising content using the plurality of user devices and using the one or more digital media files to create such advertising content; (6) submitting the created advertising content for posting; and (7) posting the created advertising content on the plurality of social media networks.

In one embodiment, the step of submitting the created advertising content for posting further includes the step of authorizing the created advertising content for posting on the plurality of social media networks. In another embodiment, the method of mass advertisement creation further includes the step of individually associating the posted created advertising content with each respective user that created the created advertising content. In yet another embodiment, the method of mass advertisement creation further includes the step selecting a user of posted created advertising content to receive an award based on particular submitted created advertising content created by that user.

In one embodiment, the step of selecting a user of posted created adverting content to receive an award based on particular submitted created advertising content further includes the steps of determining the number of views each posted created advertising content receives and selecting a winner based on the posting that received the most views on the plurality of social media platforms. In another embodiment, the method of mass advertisement creation further includes the step of creating a professional advertisement using the posted created advertising content created by the selected user.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a schematic view of a web-based social advertising system according to one embodiment of the disclosure;

FIG. 2 shows an example of a web-based social advertising system according to one embodiment of the disclosure; and

FIG. 3 shows a schematic view of user profile data stored on a web-based social advertising system according to one embodiment of the disclosure.

### DETAILED DESCRIPTION

Various terms used herein are intended to have particular meanings Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control

“in communication”: capability of electronic communication between two or more devices with or without a direct physical connection between such two or more devices (i.e., wired or wireless).

Computer: a device including a processor that is configured for connecting to a network such as, for example, the Internet.

Database: a structured set of data stored on a computer or other similar hardware configurable to be accessed by one or more external computers, and may be located in a single geographic location or spread across multiple computers in varying geographic locations. As used herein, this term may be interpreted to include one or more processors, data storage devices, and other hardware for transmitting, interpreting, and/or receiving data.

Platform: a communication network connected together through a specific protocol, code language, and/or other means including, for example, a social network (e.g., Twitter®, Facebook®, Vine™, Foursquare®).

Any and all hardware described herein is understood to be powered using electric power, but the source(s) of such electric power may vary including, without limitation, any and all forms of green energy that can be used to provide or otherwise convert energy to electric power available for use.

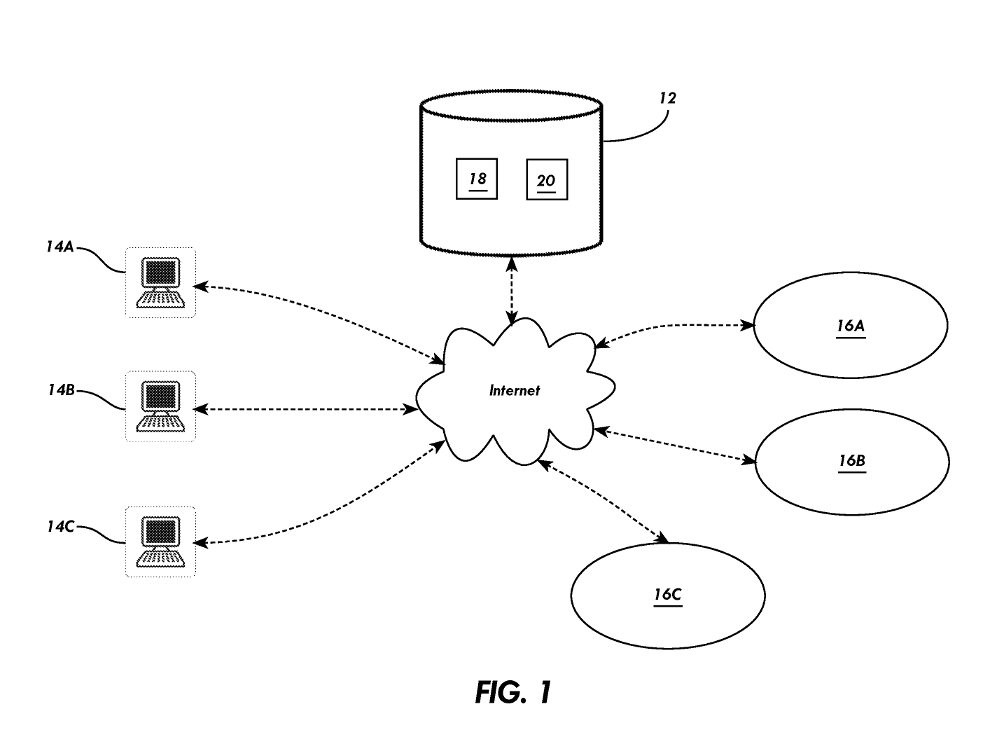

FIG. 1 shows a basic embodiment of a web-based social advertising system 10 including a solicitation database 12, one or more user devices 14A-14C and one or more social media networks 16A-16C. The solicitation database 12 is in communication with the one or more user devices 14A-14C and the one or more social media networks through a communications network such as, for example, the Internet, an intranet or a local area network. The web-based social advertising system allows one or more users to accept a solicitation to create an advertisement from the solicitation database and share the advertisement via a social media profile of the one or more users, and further for the solicitation database to select one or more of the users to receive compensation for the user's created advertisement.

The solicitation database includes a data storage device 18 and a processor 20. The data storage device 18 may include, for example, a volatile memory storage device, a non-volatile memory storage device, a removable memory storage device, or a combination thereof. In one embodiment, the data storage device 18 includes multiple apparatuses in different locations configured to redundantly store data relevant to the advertising system 10, such as, for example, “cloud” storage. Preferably, there are a large number of data storage devices and processors used so that thousands, tens of thousands, or even hundreds of thousands data sets may be transferred and processed.

The processor 20 is in communication with the data storage device 18 and may include or otherwise take the form of a central processing unit including, for example, one or more microprocessors; an application-specific instruction-set processor; a network processor; a vector processor, a scalar processor, or any combination thereof; or any other control logic apparatus now known or later developed that is capable of performing the tasks described herein; or any combination thereof. In one embodiment, the processor 20 includes multiple processors in more than one geographic location in communication with the data storage device 18.

The one or more user devices 14A-14C may include a personal computer, smartphone, tablet, or other similar hardware now known or later developed for communicating with the solicitation database 12. In one embodiment, a user profile for the advertising system 10 is created by a user and stored on the data storage device 18 of the solicitation database 12. The user profile includes data related to an individual user of the solicitation database such as the user's name, location, data related to one or more social media profiles of a user such as a user's Facebook®, Twitter®, YouTube®, LinkedIn® and other similar social media services accounts. When a user creates the user profile, the user further may agree to terms and conditions of the advertising system 10 such as agreeing to assign all rights in any copyrights of advertising content created by the user to the owner and/or licensor of the advertising system 10.

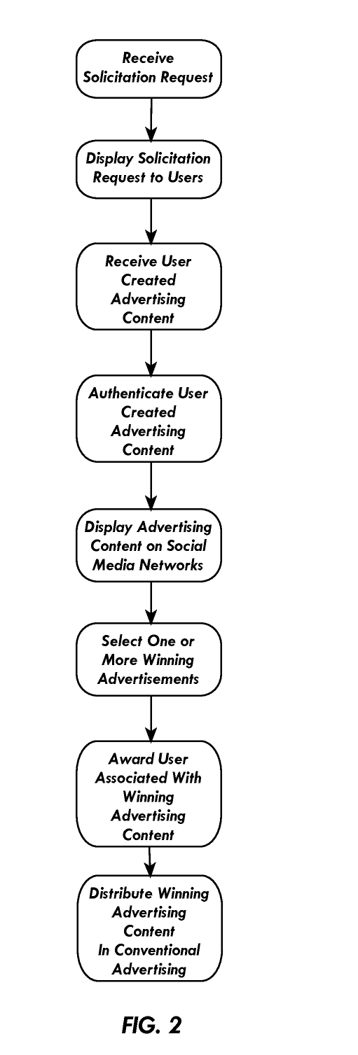

Referring now to FIG. 2, one or more solicitation requests (preferably thousands) are stored on the data storage device 18 of the solicitation database 12. The one or more solicitation requests include requests from third parties (e.g., businesses) for the creation of one or more advertisements related to a good or service offered by the particular business that issued the solicitation request. The solicitation request preferably includes various parameters of an advertisement desired by the third party such as, for example, a brand name, a slogan, a logo, artwork, or other information to be used in the advertisement(s) along with other various parameters related to a desired marketing campaign of the third party business. The solicitation request further includes a description of an award to be given or otherwise transferred to the user or users that create the best advertisement. Advertisements may vary by solicitation request and may come in the form of video material, audio material, images, cartoons, slogans, photographs, audio-visual materials and/or other formats requested by a third party. Certain ads may lend themselves to certain social media platforms such as, for example, text/photograph for Twitter®, short videos for Vine®, images for Pinterest® and the like.

After storing one or more of the solicitation requests on the data storage device 12, users may access the one or more solicitation requests through the one or more user devices 14A-14C in communication with the solicitation database 12 via the communications network. The stored solicitation requests are displayed to the user through the one or more user devices 14A-14C including a summary of the solicitation request that includes data such as the particular brand or type of product to be advertised along with a summary of advertising parameters for the particular solicitation request.

When a user accepts a solicitation request, the user is preferably required to accept various terms and conditions in connection with the particular solicitation request. The terms and conditions preferably include various authorizations and/or specific licensing terms for the user to make limited use of various trademarks, copyrights, or other material owned by one or more third parties and associated with the solicitation request for the purpose of creating advertising content. The terms and conditions associated with a solicitation request are preferably accepted via a click through user agreement wherein a user manifests his, her, or its consent to such terms by checking a box, placing a digital signature, or other electronic means of authenticating a user's manifest assent to particular terms and conditions. Upon a user accepting the terms and conditions associated with a particular solicitation request, the solicitation database receives notice that the terms and conditions have been accepted by the applicable user and then the solicitation database transmits any artwork or related content to the particular user for the limited purpose of creating a social media advertisement within the terms of the particular solicitation request. Such artwork or related content may then be used to be transformed into unique advertising content by the user.

In one embodiment, the advertising system 10 must authorize user created advertising content before posting the advertisement and/or allowing a user to share the advertising content on the user's one or more social media profiles. Preferably, each user's social media profile information (e.g., access information such as usernames and passwords) for various social media platforms 16A-16C is stored in the data storage device 18, preferably via encryption. For example, after a user creates advertising content according to parameters associated with a solicitation request, the user transmits the created advertising content to the solicitation database 12 via the one or more user devices 14A-14C for authorization. The advertising system 10 then verifies that the created advertising content satisfies the parameters of a particular solicitation request and is not otherwise offensive or does not misuse or abuse content provided by the solicitation database for the creation of advertising content as desired by the third party. Such verification step may include transmitting the created advertising content to the applicable third party (e.g., the third party marketing and/or legal department) for review and then having the third party accept or reject the created advertising content wherein such acceptance or rejection is transmitted back to the solicitation database 12. In some situations, the third party may take the created advertising content and alter such content on its own prior to accepting such content. For example, some third parties may require in their terms and conditions that any and all copyrights in any created advertising content are automatically assigned to the third party, thereby allowing the third party to use any created advertising content it sees fit, regardless of whether the third party allows the created advertising content to be posted. In one example, authorization of the advertising content may be required before a user posts created advertising content to the one or more social media networks 16A-16C. Alternatively, a more reactive form of authorization may occur after a user posts created advertising content to the one or more social media networks 16A-16C wherein the solicitation database 12 (automatically or in response to a transmission from the applicable third party) removes created advertising content posted by the user on the one or more social media networks 16A-16C. Such removal may occur, for example, if the created advertising content does not comply with the parameters of a particular solicitation request or is offense or misuses or abuses content provided by the solicitation database for the creation of advertising content as desired by the applicable third party.

After a user creates advertising content in response to a solicitation request and after the created advertising content is authorized (if required), the user and/or the solicitation database 12 post the created advertising content on, for example, the user's one or more social media profiles of the one or more social media platforms 16A-16C. The created advertising content may be posted on the one or more social media platforms 16A-16C via the one or more user devices 14A-14C such that the created advertising content is displayed to other users of the one or more social media platforms 16A-16C.

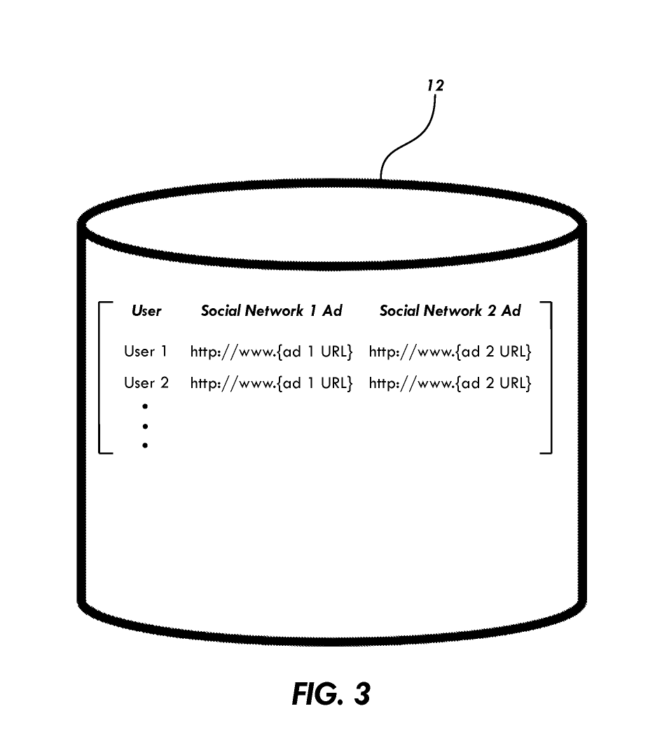

Upon posting of the created advertising content to the one or more social media platforms 16A-16C, the created advertising content is preferably associated with one or more user profiles of the advertising system 10 as illustrated in FIG. 3. For example, one or more uniform resource locator (“URL”) addresses corresponding to an address of the created advertising content is stored on the data storage device 18 of the solicitation database 12 along with other data related to a particular user's profile.

In one embodiment, the solicitation database 12 is in communication with one or more of the user profiles of the one or more social media networks 16A-16C through an application programming interface (“API”), wherein the solicitation database 12 may access advertising content posted by the one or more users to associate the advertising content with the one or more users. Further, the API may be configured to allow the solicitation database 12 to directly remove any posted created advertising content that does not comply with the parameters of a particular solicitation request.

In another embodiment, the solicitation database 12 associates advertising content created by a user with the user's profile stored on the data storage device 18 using a “tag” feature that associates such profile with a word or phrase affiliated with the solicitation request or other indicator. For example, an indicator may include a commonly used hash tag along with a word or phrase associated with the solicitation request. The indicator is posted on the one or more social media networks along with the created advertising content. In this example, the processor 20 of the solicitation database 12, which is in communication with the one or more social media networks and user profiles stored thereon, detects the presence of the hash tag and word or phrase in a post generated by the user on the user's one or more social media profiles and associates that post as advertising content created by the user in connection with one or more of the solicitation requests. The solicitation database 12 may monitor any new postings of the one or more users on their social media network profiles, and if an indicator is present in the postings of the one or more users of the social media networks, the solicitation database 12 associates the particular tagged posting with the user's profile stored on the solicitation database 12.

After the created advertising content is associated with one or more users of the advertising system 10, one or more users are selected for one or more awards (e.g., monetary compensation, gift card, credits to the third party business) based on the user's created advertising content. For example, the third party that submitted the solicitation request to the solicitation database 12 may view all created advertising content associated with the one or more users and select one or more users to be awarded based on advertising content that is most preferred by the third party. The solicitation database 12 may be used to transfer award information to one or more of the users that generate the best advertising content as designated by the third party or business that submitted the original solicitation request and solicitation request parameters.

In one alternative embodiment, the one or more users to be awarded are selected based on data related to the created advertising content that is posted. The data related to the posted created advertising content corresponds to, for example, a number of times that created advertising content is viewed, clicked on, liked, re-posted or otherwise selected and/or viewed by others.

The third party that submitted the solicitation request to the solicitation database 12 may optionally reproduce and distribute the created advertising content selected to be awarded in various other conventional advertising mediums, as shown in FIG. 2, thereby further transforming the created advertising into a more tangible form. Alternatively, if the copyright in such created advertising content is owned by the owner and/or licensor of the advertising system 10, such owner/licensor may optionally auction off such created content to persons or entities other than the solicitation requester, or, for example, license such content to the third party requestor for a premium licensing fee wherein such licensing fee can be based, for example, at least in part on the nature of the license (e.g., exclusive versus non-exclusive) and/or the popularity of the created advertising content, wherein such popularity is based, for example, on social media analytics related to the created advertisement. The third party requester or other owner of the copyright in a created advertisement may alter the awarded advertising content such that the advertising content may be utilized with various other products or brands (e.g., brands sold by the third party that submitted the particular solicitation request or brands sold by a highest bidder bidding with the owner of the copyright in the created advertisement).

Preferably, the solicitation database 12 further tracks various analytics and performance parameters of advertising content created by the users and associated with the each user's profile stored on the solicitation database 12. For example, the solicitation database 12 tracks the number of times that an ad created by a user and posted by the user on the one or more social media networks 16A-16C are clicked on by various other persons using the one or more social media networks 16A-16C. Information on persons that click on a posted advertisement preferably is also collected such as, for example, demographic information of the person that clicked on the posted advertisement. The solicitation database 12 may generate one or more reports based on advertising content analytics and transmit reports to the one or more third parties or businesses that submitted the solicitation request(s). Additionally, reports may be generated and transmitted by the solicitation database to the one or more users regarding each user's particular generated advertising content to enable the users to review the efficacy of their respective generated advertising content.

Various pricing plans have been conceived using the advertising system 10 as a business model including charging system users certain fee structure as well as the third party requesters. In one example, users are charged at varying rates depending on, for example, the number of ad requests for which a user chooses to submit a created ad. Additionally or alternatively, users can be charged a blanket fee per month for submitting as many created ads as they desire. Another option is for users to be allowed to submit as many created ads as they would like at no charge while third party requesters are charged for ad requests using one or more pricing models (e.g., per submitted created ads in response to the particular ad request [similar to a pay per click payment system] or a blanket fee per ad request). In one example, both third party requestors and users making more than, for example, five created ad submissions are required to pay either a recurring membership fee and/or a la cart fee. For third party requesters, pricing is preferably increased based on a scale of increasing access to advertising system 10 analytics, such analytics including, for example, information related to the types of persons that “like”, vote for, or otherwise support a particular created ad.

In one embodiment, one or more third party or business profiles are stored on the data storage device 18 corresponding to the one or more solicitation requests submitted to the solicitation database 12. The one or more third party or business profiles include data related to each particular third party or business such as, for example, the third party's name or business name, type of products sold by the third party or business, and other related information. In this embodiment, the one or more users of the advertising system 10 may search for a particular third party or business profile and determine whether any solicitation requests are currently associated with the particular third party or business. For example, if a user takes a relevant photograph or recently has a positive experience with a particular company, the user may search the solicitation database 12 for a particular profile associated with the company along with any current solicitation requests by the company to determine whether the company is seeking advertising content for a particular branded product or service offered by that company.

The web-based social advertising system 10 allows a third party business to commission the creation of a variety of advertising content by users of the solicitation database. In one embodiment, such users can then post the created advertising content on the one or more social media networks 16A-16C, thereby achieving dissemination of voluminous advertising content for the third party to a wide audience among the various users' friends and connections on the social media networks 16A-16C. The third parties or businesses that submit the solicitation requests thereby receive a wider audience via significantly more ads at a significantly reduced cost relative to hiring a formal advertising agency to disseminate a single advertisement for a third party or business. Moreover, in this example the audience of the advertising content is more likely to be influenced by the advertising content because the advertising content is posted by the one or more users (similar to “word of mouth” advertising) and is not displayed as paid or promoted advertising of the third party or business.

The web-based social advertising system 10 further encourages the one or more users to create and distribute quality advertising content related to the third party or business due to the chance that at least one of the users' created advertising content will be selected by the third party or business as the best advertising content for a particular solicitation request, thereby resulting in an award to the user.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by any future claims when interpreted in accordance with the breadth to which they are fairly, legally, and equitably entitled.

What is claimed is:

1. A method of mass advertisement creation comprising the steps of:
a. providing a web-based social advertising system comprising a solicitation database, a plurality of user devices, and a plurality of social media networks wherein the solicitation database is in communication with the plurality of user devices and the plurality of social media networks through a communications network selected from the group consisting of the Internet, an intranet, or a local area network;
b. storing a solicitation request on a data storage device of the solicitation database wherein such solicitation request includes one or more digital media files for use by a user to create advertising content;
c. accessing the solicitation request via the plurality of user devices;
d. accepting a solicitation request via the plurality of user devices;
e. creating advertising content using the plurality of user devices and using the one or more digital media files to create such advertising content;
f. submitting the created advertising content for posting; and
g. posting the created advertising content on the plurality of social media networks.

2. The method of mass advertisement creation of claim 1 wherein the step of submitting the created advertising content for posting further comprising the step of authorizing the created advertising content for posting on the plurality of social media networks.

3. The method of mass advertisement creation of claim 2 further comprising the step of individually associating the posted created advertising content with each respective user that created the created advertising content.

4. The method of mass advertisement creation of claim 3 further comprising the step selecting a user of posted created advertising content to receive an award based on particular submitted created advertising content created by that user.

5. The method of mass advertisement creation of claim 4 wherein the step of selecting a user of posted created adverting content to receive an award based on particular submitted created advertising content further comprises the steps of determining the number of views each posted created advertising content receives and selecting a winner based on the posting that received the most views on the plurality of social media platforms.

6. The method of mass advertisement creation of claim 4 further comprising the step of creating a professional advertisement using the posted created advertising content created by the selected user.
